(19) United States
(12) Patent Application Publication
(10) Pub. No.: US 2026/0299898 A1
(43) Pub. Date: Oct. 1, 2026

(54) CODE GENERATION USING A SELF-LEARNING SYSTEM

(71) Applicant: ADP, Inc., Roseland, NJ (US)

(72) Inventors: Allan Barcelos Silva, Porto Alegre (BR); Achraf Tounsi, Roseland, NJ (US); Matheus Westhelle, Porto Alegre (BR); Neisarg Dave, Roseland, NJ (US)

(73) Assignee: ADP, Inc., Roseland, NJ (US)

(21) Appl. No.: 19/094,523

(22) Filed: Mar. 28, 2025

(51) Int. Cl. G06F 8/35; G06F 11/34

(52) U.S. Cl. CPC G06F 8/35; G06F 11/3466

(57) ABSTRACT

A system for code generation using a self-learning system is described. A data processing system can receive a command to generate a computer program comprising instructions that execute a network operation in a computing environment. A data processing system can generate a plurality of computer programs using a pool of models, each model initialized using a dictionary. A data processing system can select, based on an evaluation by the pool of models of the plurality of computer programs, a first computer program from the first plurality of computer programs, the selection based on the first computer program satisfying a metric. A data processing system can execute, responsive to the selection, the first computer program in the computing environment. A data processing system can evaluate the performance of first computer program’s execution in the computing environment. A data processing system can perform an action, based on the evaluation.

### TECHNICAL FIELD

This application is generally related to computing technology, and particularly to generating computer code using a self-learning system.

### BACKGROUND

A computing system can be instructed to perform various actions through computer code. Due to the complexity of code generation, it can be challenging to efficiently and reliably generate code that is suited for handling complex issues, thereby introducing delays, latency, and utilizing unnecessary computing resources when code generation is requested for complicated issues.

### SUMMARY

Aspects of the technical solutions described herein are directed at computing architecture and, more particularly, a machine learning architecture for generating code. For example, aspects of the technical solution can use multiple generative artificial intelligence (AI) models, such as Large Language Models, that can be configured to collaborate and generate code. Due to the increasingly complex and high-stakes coding problems received by computing systems, it can be technically challenging for a system to accurately and correctly generate code that addresses the problems, let alone generate code for issues where documents are ambiguous or subject to frequent regulatory changes. For example, tax documents often contain ambiguous language, detailed computations, and nuanced rules that need precise interpretation and accurate translation into executable code. Additionally, tax laws change frequently, requiring code to adapt accordingly. Traditional automated code generation struggles with these challenges, leading to unreliable or incorrect outputs, and unnecessary use of computer resources.

Aspects of the technical solutions can manage complex and ambiguous documents while producing functionally correct and quality code. For example, the system’s self-learning ability and ability to continuously build a knowledge base using successful and unsuccessful solutions allows the system to adapt to novel circumstances. The technical solutions can implement filtering mechanisms capable of validating code. For example, the system can integrate tools to not only validate the syntax of the code, but also the functional correctness and quality of the code. For instance, in the tax document domain the system can address the complex and highly regulated nature of tax documents by generating quality, functional code that builds on past solutions and failures. This approach can prevent imprecise code, improve the delivery of digital content, improve computational efficiency and energy system consumption.

The computing architecture of the technical solutions described herein can provide a flexible computational approach configured to adapt to varied and nuanced requests via multiple models tailored to collaborate among each other when generating code. Additionally, by leveraging self-learning models, the system can generate improved code after an iteration of code generation.

In some aspects, the techniques described herein relate to a system, including a data processing system including one or more processors coupled with memory. The processors can receive a command to generate a computer program including computer-executable instructions that execute a network operation in a computing environment. The processors can generate a plurality of computer programs using a pool of models, each model initialized using a respective parameter dictionary. The processors can select, based on an evaluation by the pool of models of the plurality of computer programs, a first computer program from the first plurality of computer programs, the selection is based on the first computer program satisfying a performance metric. The processors can execute, responsive to the selection, the first computer program in the computing environment evaluate the performance of the execution of the first computer program in the computing environment. The processors can perform an action, based on the evaluation.

In some aspects, the processors can determine, based on an evaluation of the execution of the first computer program in the sandbox environment, that the first output does not satisfy at least one performance metric. The processors can generate a second plurality of computer programs using the pool of models, each model provided an indication of the performance metric that was not satisfied by the first computer program. The processors can select, based on an evaluation by the pool of models of the second plurality of computer programs, a second computer program from the second plurality of computer programs that satisfies the performance metric. The processors can execute, responsive to the selection, a second computer program in the computing environment.

In some aspects, the techniques described herein relate to a system, wherein the parameter dictionary can include at least one of a temperature parameter, a memory parameter, a randomness parameter, a context parameter, a model parameter, or an engine parameter.

In some aspects, the processors can configure a sandbox environment to include a data schema, a system architecture and data configured for the data schema, where the data schema and system architecture are configured to facilitate a transfer of currency. The processors can determine based on an application of a plurality of evaluation tools, the first computer program satisfies an evaluation metric. The processors can determine based on the evaluation of the execution of the first computer program in the sandbox environment, that the first computer program caused a transfer of a predetermined amount of currency from a first bank account to a second bank account on a predetermined date according to instructions contained in the network operation.

In some aspects, the processors can configure the sandbox environment to include a data schema, a system architecture and data configured for the data schema, where the data schema and system architecture are configured to complete a tax related document. The processors can determine, based on an application of a plurality of evaluation tools, the first computer program includes code that satisfies an evaluation metric. The processors can and determine, based on an evaluation of the execution of the first computer program in the sandbox environment, that the first computer program completed the tax related document according to standards and instruction contained in the network operation.

In some aspects, the techniques described herein relate to a system, wherein the execution of the computer program occurs in a sandbox environment corresponding to the computing environment.

In some aspects, the processors can select the parameter dictionary corresponding to a type of network operation and a type of computing environment. The processors can use the parameter dictionary corresponding to the type of network operation and the type of computing environment to initialize the pool of models.

In some aspects, the processors can use a machine learning model to identify a plurality of parameters based on a type of network operation indicated by the command. The processors can initialize the pool of models using the parameters identified by the machine learning model.

In some aspects, the processors can select, based on a plurality of evaluations by the pool of models of the plurality of computer program, a third computer program, wherein the third computer program differs from the first computer program and the second computer program. The processors can execute, responsive to the selection, the third computer program in the sandbox environment corresponding to the computing environment.

In some aspects, the processors can input a type of the network operation or a type of the computing environment into a machine learning model to generate a computer program. The processors can identify, based on the computer program from the machine learning model, the performance metric to use to evaluate the plurality of computer program.

In some aspects, the processors can use a pool orchestrator component, different from the pool of models, to select, based on the command, a profile of parameters from the parameter dictionary with which to initialize the pool of models. The processors can initialize the pool of models using the selected profile of parameters.

In some aspects, the techniques described herein relate to a system, wherein each model of the pool of models include: i) a memory component, ii) a context component, iii) a tools component, and iv) a framework component, the one or more processors to: store, in the memory component of each model of the pool of models, in accordance with the parameter dictionary used to initialize the pool of models, information related to one or more evaluations of the plurality of outputs.

In some aspects, the processors can select a memory component of each model of the pool of models that corresponds to the context component of each model of the pool of models. The processors can update the memory component of each model of the pool of models with the context component of each respective model of the pool of models based on the parameters of each model of the pool of models.

In some aspects, the processors can provide the plurality of outputs to each model of the pool of models to cause each model of the pool of models to evaluate, based on the memory component of each model of the pool of models, the plurality of outputs. The processors can select, based on the evaluation of the plurality of outputs, an output from the plurality of outputs.

In some aspects, the processors can configure the sandbox environment, based on a type of the network operation or a type of the computing environment, to include a containerized application, a data schema, a virtual machine, a system architecture, or data configured for the data schema.

In some aspects, the processors can initialize a voting sequence, the sequence to cause the pool of models to vote on the plurality of computer programs based the evaluation of the output by each model of the pool of models. The processors can select, based on the votes received by t In some aspects, the pool of models, the computer program from the plurality of computer program that satisfies a voting threshold. The processors can execute, responsive to the selection, the computer program that satisfies the voting threshold in the sandbox environment corresponding to the computing environment.

In some aspects, the techniques described herein relate to a method. The method can include a data processing system including one or more processors, coupled with memory. The method can include receiving, by one or more processors, a command to generate a computer program including computer-executable instruction that execute a network operation in a computing environment. The method can include generating, by one or more processors, a plurality of computer programs using a pool of models, each model initialized using a respective parameter dictionary. The method can include selecting, by one or more processors, based on an evaluation by the pool of models of the plurality of computer programs, a first computer program from the first plurality of computer programs, the selection is based on the first computer program satisfying a performance metric. The method can include executing, by one or more processors, responsive to the selection, the first computer program in the computing environment. The method can include evaluating, by the one or more processors, the performance of the execution of the first computer program in the computing environment. The method can include performing, by the one or more processors, an action, based on the evaluation.

In some aspects, the techniques described herein relate to a method. The method can include determine, based on an evaluation of the execution of the first computer program in the sandbox environment, that the first output does not satisfy at least one performance metric. The method can include generate a second plurality of computer programs using the pool of models, each model provided an indication of the performance metric that was not satisfied by the first computer program. The method can include select, based on an evaluation by the pool of models of the second plurality of computer programs, a second computer program from the second plurality of computer programs that satisfies the performance metric. The method can include build, responsive to the selection, a second computer program to execute the network operation in the computing environment.

In some aspects, the techniques described herein relate to a method. The method can include using, by one or more processors, a machine learning model to identify a plurality of parameters based on a type of network operation indicated by the command. The method can include initializing, by one or more processors the pool of models using the parameters identified by the machine learning model.

In some aspects, the techniques described herein relate to a method. The method can include using, by one or more processors, a pool orchestrator component, different from the pool of models, to select, based on the command, a profile of parameters from the parameter dictionary with which to initialize the pool of models. The method can include initializing, by one or more processors, the pool of models using the selected profile of parameters.

In some aspects, the techniques described herein relate to a method. The method can include configuring, by one or more processors, a sandbox environment to include a data schema, a system architecture and data configured for the data schema, where the data schema and system architecture are configured to facilitate a transfer of currency. The method can include determining, by one or more processors, based on an application of a plurality of evaluation tools, the first computer program satisfies an evaluation metric. The method can include determining, by one or more processors, based on the evaluation of the execution of the first computer program in the sandbox environment, that the first computer program caused a transfer of a predetermined amount of currency from a first bank account to a second bank account on a predetermined date according to instructions contained in the network operation.

In some aspects, the techniques described herein relate to a method. The method can include configuring, by one or more processors, a sandbox environment to include a data schema, a system architecture and data configured for the data schema, where the data schema and system architecture are configured to complete a tax related document. The method can include determining, by one or more processors, based on an application of a plurality of evaluation tools, the first program satisfies an evaluation metric. The method can include determining, by one or more processors, based on the evaluation of the execution of the first computer program in the sandbox environment, that the first computer program completed the tax related document according to standards and instruction contained in the network operation.

In some aspects, the techniques described herein relate to a non-transitory computer-readable medium including instructions that, when executed by one or more processors coupled with memory, cause the one or more processors to receive a command to generate a computer program including computer-executable instruction that execute a network operation in a computing environment. The instructions can generate a plurality of computer programs using a pool of models, each model initialized using a respective parameter dictionary. The instructions can select, based on an evaluation of the plurality of computer programs, a first computer program from the first plurality of computer programs, the selection is based on the first computer program satisfying a performance metric. The instructions can execute, responsive to the selection, the computer program in the computing environment.

### BRIEF DESCRIPTION OF THE FIGURES

These and other aspects and features of the present implementations are depicted by way of example in the figures discussed herein. Present implementations can be directed to, but are not limited to, examples depicted in the figures discussed herein. Thus, this aspect is not limited to any figure or portion thereof depicted or referenced herein, or any aspect described herein with respect to any figures depicted or referenced herein.

FIG. 1 depicts an example system for code generation using a self-learning system, according to one or more aspects.

FIG. 2 depicts an example system for code generation using a self-learning system according to one or more aspects.

FIG. 3 illustrates a block diagram of an example computing system for implementing the embodiments of code generation using a self-learning system according to one or more aspects.

FIG. 4 illustrates an example system for code generation using a self-learning system according to one or more aspects.

FIG. 5. is a flow diagram illustrating an example method for code generation using a self-learning system. according to one or more aspects.

### DETAILED DESCRIPTION

Aspects of technical solutions are described herein with reference to the figures, which are illustrative examples of the technical solutions. The figures and examples below are not meant to limit the scope of the technical solutions to the present implementations or to a single implementation, and other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein. Further, the technical solutions and the present implementations encompass present and future known equivalents to the known components referred to herein by way of description, illustration, or example.

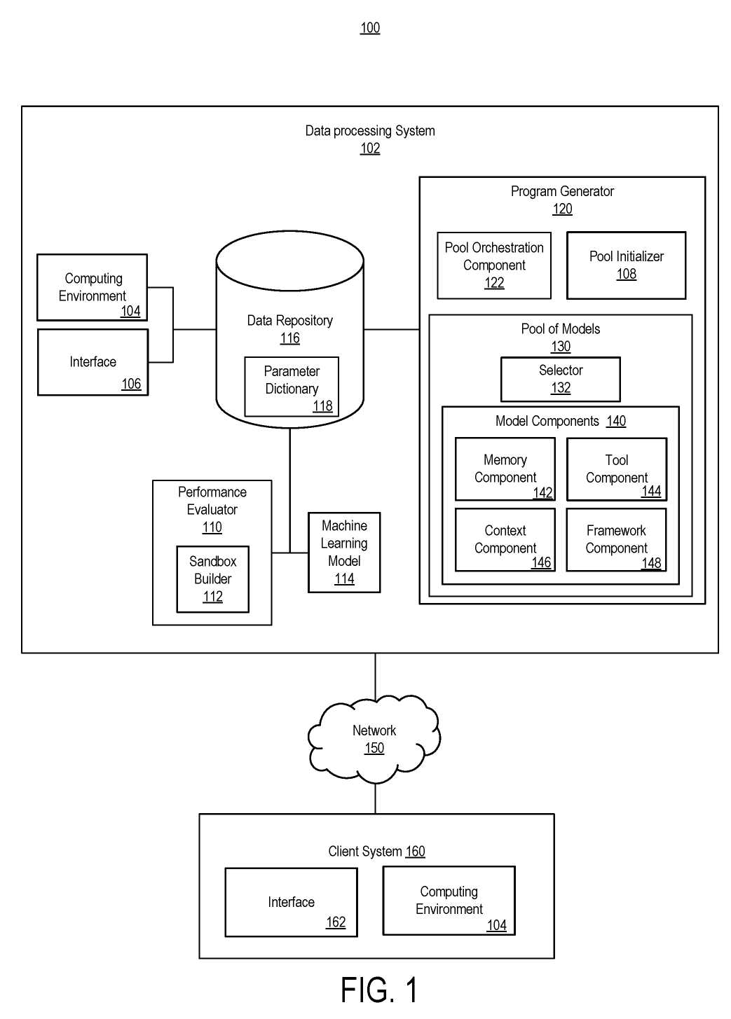

FIG. 1 depicts an example system 100 for code generation using a self-learning system, according to one or more aspects. System 100 can include, interface, or otherwise communicate with a client system 160 communicating with a data processing system (DPS) 102 over a network 150. The data processing system 102 can include or operate an interface 106 that can receive a command to generate a computer program comprising computer-executable instructions. In some examples, the generated computer program is executable in a specific computing environment, such as computing environments 104. The data processing system 102 can include or operate a program generator 120 to initialize a pool of models 130. The program generator 120 can include a pool initializer 108 that initiates or initializes the pool of models 130. The pool initializer 108, in some examples, uses a parameter dictionary 118 located in the data repository 116 to initiate or initialize the pool of models 130. In some examples, each model from the pool of models 130 is initialized using a respective parameter dictionary 118. The data processing system 102 can generate a plurality of computer programs using the pool of models 130. The system 100 can include one or client systems 160.

The pool of models 130 can include a selector 132. The selector 132 can include any combination of hardware and software for selecting programs. The selector 132 can select, based on an evaluation of the plurality of computer programs, a first computer program from the plurality of computer programs. In some examples, the selection is based on the first computer program satisfying a performance metric. In some examples, the data processing system 102 can include a performance evaluator 110. The performance evaluator 110 executes, responsive to the selection, the first computer program in the computing environment 104. The performance evaluator 110 can further evaluate the performance of the execution of the first computer program using performance metrics. In some examples, the performance metrics are stored in the data repository 116. The performance evaluator 110 can determine, based on the evaluation of the execution, whether the first computer program satisfies the performance metrics. In some examples, the data processing system 102 can perform an action based on the evaluation. For example, the data processing system 102 can provide an indication to the pool of models 130 to generate a second plurality of computer programs if the first computer program does not satisfy the performance metrics. The data processing system 102 can perform an action, based on the evaluation.

The data processing system 102 can include a physical computer system operatively coupled or able to be coupled with one or more components of the system 100. The data processing system 102 can include a virtual computing system, an operating system, or a communication bus to effect communication and processing. The data processing system 102 can include a computing environment 104, an interface 106, a performance evaluator 110, a machine learning model 114, a data repository 116, and a program generator 120.

The interface 106 can facilitate the data processing system 102 to communicate electronically via the network 150. For example, the data processing system 102 can communicate with the client system 160. The interface 106 can include one or more communication interfaces. A communication interface can include, for example, an application programming interface (“API”) compatible with a particular component of the data processing system 102, the client system 160, and any other component. In another example, a communication interface can use a network (e.g., network 150) connected to the data processing system 102 or the client system 160. The communication interface can use a particular communication protocol compatible with a particular component of the data processing system 102. The communication interface may use the same or a different communication protocol when communicating with a particular component of the client system 160. The interface 106 can be compatible with particular content objects and can be compatible with particular content delivery systems corresponding to particular content objects, structures of data, types of data, are amendments/arguments we made for EP-specific practices. For example, the interface 106 can be compatible with transmission of text data or binary data structured according to one or more metrics or data of the client system 160. The interface 106 can receive input from the client system 160 via the network 150.

The parameter dictionary 118 can include or be a set of parameters used to initialize a model from the pool of models 130. The parameter dictionary 118 can include at least one of a temperature parameter, a memory parameter, a randomness parameter, a context parameter, a model parameter, a reasoning parameter, an engine parameter, a learning rate parameter, a batch size parameter, an epoch parameter, a momentum parameter, a dropout rate parameter, a regularization parameter, an optimizer parameter, a role parameter, an activation function parameter, or a hyperparameter. Additional types of parameters are possible in other examples. The parameter dictionary 118 can be selected or set by the client system 160, by random, the pool initializer 108, the program generator 120, by the pool orchestration component 122, or a combination thereof.

The data repository 116 can store data associated with the system 100, the data processing system 102, or a combination thereof. The data repository 116 can be a computer-readable memory that can store or maintain any of the information described herein. The data repository 116 can maintain one or more data structures, which may contain, index, or otherwise store each of the values, pluralities, sets, variables, vectors, numbers, or thresholds described herein. The data repository 116 can be accessed using one or more memory addresses, index values, or identifiers of any item, structure, or region maintained in the data repository 116. The data repository 116 can be accessed by the components of the data processing system 102, or any other computing device described herein, via the network 150. The data repository 116 can be internal to the data processing system 102. The data repository 116 can exist external to the data processing system 102 and may be accessed via the network 150. For example, the data repository 116 may be distributed across many different computer systems (e.g., a cloud computing system) or storage elements and may be accessed via the network 150 or a suitable computer bus interface.

The program generator 120 can include, provide, execute, operate or otherwise utilize the pool of models 130. The pool of models 130 can include any combination of hardware and software for implementing one or more machine learning (ML) models 114. The pool of models 130 can be or include one or more models. The pool of models 130 can utilize, include, or operate one or more selectors 132, pool orchestration component 122, and model components 140. The model components can utilize, include, or operate one or more memory components 142, tool components 144, context components 146, framework components 148, or any combination thereof. The memory component 142 can include previously generated computer programs and previous evaluations based on the network operation. The context component 146 can include whether other models from the pool of models 130 have generated computer programs and what the computer programs are. The tool component can include compilers, linters, analyzers, static analyzers, or other such computer programming tools. The framework component can include Tree-of-Thoughts, Reasoning and Acting (ReAct), Self-Consistency, Plan-and-Solve, Deliberation Networks, Iterative Prompting, Meta-Reasoning, Hierarchical Planning, Prompt Chaining, Zero-Shot Tree of Thoughts (Zero-Shot ToT), Multi-Agent Collaboration, AutoCodeRover, Contextual Memory Networks, any other computer programming frameworks, or any combination thereof. The Model components 140 can combine any portions of the memory component 142, tool component 144, context component 146, or framework component 148.

In an example, the pool of models 130 can be distributed across client systems 160 where one or more model of the pool of models 130 can be respectively located on one or more client systems 160. One or more client systems 160 can be used for one or more models of the pool of models 130 respectively.

The pool of models 130 can include one or more of generative artificial intelligence models, large language models (LLM), small language models (SLM), generative adversarial networks, variational autoencoders, transformers, or diffusion models. The pool of models 130 can further include one or more of linear regression models, logistic regression models, decision tree models, random forest models, support vector machines (SVM), k-nearest neighbors (KNN), neural network, convolutional neural networks (CNNS), recurrent neural networks (RNNS), gradient boosting machines (GBM).

The program generator 120 can store, in the memory component of each model of the pool of models 130, in accordance with the parameter dictionary 118+* used to initialize the pool of models 130, information related to one or more evaluations of the plurality of computer programs. The program generator 120 can assign each one or more roles to a model from the pool of models 130. The roles are assigned using the network operation, the computing environment 104, or the pool initializer 108. The role indicates a type of team member or the function to be performed by the assigned model. For example, the roles can include one or more of software developer, project manager, front-end developer, back-end developer, full stack developer, development and operation engineer, quality assurance (QA) engineer, UI/UX designer, database administrator (DBA), system architect, security engineer, product manager, technical writer, scrum master, mobile developer, data scientist, machine learning engineer, or any combination thereof. Other roles can be included in other examples. Each model from the pool of models 130 can communicate with one or more of the other models from the pool of models 130 to exchange data. The data can include ideas, computer programs, parameters, values, function names, APIs, computer instructions, or other types of information. In some examples, such data transfer can occur based on another model requesting the information. Alternatively, or in addition, the data transfer can occur unilaterally. The pool orchestration component 122 can assign roles to each model of the pool of models 130 based on the network operation or the computing environment 104.

The program generator 120 can include, provide, execute, operate or otherwise utilize the pool orchestration component 122. The pool orchestration component 122 can select the parameter dictionary 118 based on the command, the computing environment 104, or the network operation. The pool orchestration component 122 can update the model components 140 of the pool of models 130 based on the network operation and the computing environment 104.

The computing environment 104 can include any combination of hardware and software for running or executing programs. The computing environment 104 can be located on the client system 160 or be utilized by the client system 160. The computing environment 104 can include a system for payroll operation, processing tax documents, building programs, human resources platform, benefits administration, compliance platform, analytics platform, any other such computing systems or other such systems. The computing environment 104 located on the data processing system 102 can be configured to mimic the computing environment 104 located on the client system 160 in a containerized application. The computing environment 104 can use or include the machine learning model 114. The computing environment can include, but is not limited to, at least one microcontroller unit (MCU), microprocessor unit (MPU), central processing unit (CPU), graphics processing unit (GPU), physics processing unit (PPU), embedded controller (EC), the like, or any combination thereof. The computing environment 104 can include one or more software applications, server, computers, networking devices, operating systems, applications, databases, network infrastructures, or any combination thereof.

The computing environment 104 (e.g., an enterprise application, an enterprise server, etc.) can allow a user or the client system 160 to write a script or program using techniques described herein to automate a part of the computing environment 104 itself. For example, the computing system 104 can include a feature to accept scripts or programs that modify the aspects of the computing environment 104 (e.g., the kernel, operating system, etc.). In this example, the scripts or programs can modify the aspects of the computing environment such as the operating system, file management, the kernel, processor registers, system monitoring, user account management, task scheduling, security management, database management, application deployment, or any combination thereof.

The network 150 can include any type or form of network. The geographical scope of the network 150 can vary widely and the network 150 can include a body area network (BAN), a personal area network (PAN), a local-area network (LAN), e.g., Intranet, a metropolitan area network (MAN), a wide area network (WAN), or the Internet. The topology of the network 150 can be of any form and can include, e.g., any of the following: point-to-point, bus, star, ring, mesh, or tree. The network 150 can include an overlay network which is virtual and sits on top of one or more layers of other networks 150. The network 150 can be of any such network topology as known to those ordinarily skilled in the art capable of supporting the operations described herein. The network 150 can utilize different techniques and layers or stacks of protocols, including, e.g., the Ethernet protocol, the Internet protocol suite (TCP/IP), the ATM (Asynchronous Transfer Mode) technique, the SONET (Synchronous Optical Networking) protocol, the SD (Synchronous Digital Hierarchy) protocol, or any combination thereof. The TCP/IP Internet protocol suite can include application layer, transport layer, Internet layer (including, e.g., IPv6), the link layer, or any combination thereof. The network 150 can include a type of a broadcast network, a telecommunications network, a data communication network, a computer network, or any combination thereof.

The client system 160 can include a computing system. In some examples, the client system 160 can be associated with a database system. For example, the client system 160 can correspond to a cloud system, a server, a distributed remote system, or any combination thereof. For example, the client system 160 can include an operating system to execute a virtual environment. The operating system can include hardware control instructions and program execution instructions. The operating system can include a high-level operating system, a server operating system, an embedded operating system, or a boot loader. The client system 160 can include a user interface 162, or an instance of the computing environment 104. The client system 160 can send a network operation to the data processing system 102. The client system 160 can include the computing environment 104 of the data processing system 102. The client system 160 can utilize the computing environment 104 in a similar or same manner as the data processing system 102 can. The client system 160 can include the data processing system 102 (e.g., the client system 160 can execute or host one or more component or functionality of the data processing system 102).

The interface 162 can include one or more devices to receive input from a user or to display graphical output from a computing system (e.g., Client system 160, data processing system 102) to a user. For example, the interface 162 can correspond to a display device to display a computer program to a user. The display device can include an electronic display. An electronic display can include, for example, a liquid crystal display (LCD), a light-emitting diode (LED) display, an organic light-emitting diode (OLED) display, or the like. The display device can receive, for example, capacitive or resistive touch input. The display device can be housed at least partially within the client system 160. Additionally, or alternatively, the interface 162 includes one or more user input devices to receive input from the user. For example, the input devices can include a keyboard, a mouse, a touch-sensitive panel, or any other such input device or a combination thereof.

The data processing system 102 can receive a command to generate a computer program comprising computer-executable instructions that execute a network operation in a computing environment. In some examples, the data processing system 102 or the pool of models 130 can configure the computer-executable instructions to satisfy the command or the network operation. The computer-executable instructions can be configured to run in the computing environment 104, or in a sandbox environment built by the sandbox builder 112. The computer-executable code can be configured and modified by the pool of models 130, the program generator 120, or the machine learning model 114. In another example, the data processing system 102 can receive a command to build a program configured to execute a network operation in a computing environment 104. The data processing system 102 can receive a command to generate a computer program comprising computer-executable instructions that execute a network operation in a computing environment 104. In one example, the data processing system 102 can receive the command via the interface 106 from the client system 160. The command can include a data structure such as an object, a vector, a binary tree, a heap stack, an array, a linked list, a stack, a queue, a tree, a graph, or a hash table. The command can be mapped in a table where the command identifies a corresponding parameter dictionary 118. In this example, the pool initializer can initialize the pool of models 130 the parameter dictionary 118 that corresponds to the command. The command can indicate the type of network operation or the type of computing environment 104. The command can indicate the type of network operation or type of computing environment 104 by including a predetermined ID that indicates the type of network operation or type of computing environment 104, based on which customer the command was received from, or based on the instructions contained in the command. Examples of the network operation can include a request to compile data, execute a command, transfer data, build a program, complete tax documents, respond to a payroll request to transfer funds, or any combination thereof. Additional examples of the network operation can include authenticating users, encrypting data, and load balancing of servers.

The program generator 120 can generate a plurality of computer programs using a pool of models 130. In some examples, each model is initialized using a respective parameter dictionary 118. For example, the pool initializer 108 can initialize each model of the pool of models 130 using a respective parameter dictionary 118. The pool initializer 108 can select the parameter dictionary 118 corresponding to a type of the network operation and a type of computing environment 104. In another example, the program generator 120 can provide the command to a pool of models 130 to initialize the pool of models 130, where the command can include the parameter dictionary 118. In this example, the parameter dictionary 118 can use the parameters described herein to initialize the pool of models 130. The program generator 120 can initiate the pool of models 130 using a parameter dictionary 118 to cause the pool of models 130 to generate a plurality of computer programs responsive to the command. For example, the pool of models 130 can loop a predetermined maximum number of times to generate a plurality of computer programs in order to preserve performance. For example, the maximum number of times can be one hundred, one thousand, or one hundred and fifty times. In some examples, the data processing system 102 can provide the command via the interface 106 to the program generator 120.

The program generator 120 can cause the pool of models 130 to generate a plurality of computer programs. The program generator 120 can generate the plurality of computer programs by providing the command to the pool of models 130 In this example, providing the command to the pool of models 130 can cause the pool of models 130 to generate a plurality of portions of a computer program. Continuing in the previously mentioned example, the pool of models 130 can then combine the portions of the plurality of computer programs together to generate a computer program that satisfies the network operation or the performance metric. In some examples, the pool of models 130 can vote on each portion of the computer program individually before combining the highest voted portions of the computer program. In this example, the highest voted portion of the computer program can include different portions of a computer program that are able to be combined to form a computer program that can satisfy the network operation when run in the computing environment 104. In some examples, the plurality of portions of the computer programs can include software architecture components (e.g., front end, back end, middleware, etc.), the networking portion of a computer program, firmware components, configuration settings, application programming interface (API) portion of a program, or the user experience (UX) portion of a computer program. The program generator 120 can cause the pool of models 130 to generate a computer program in accordance with the network operation or computing environment 104 indicated by the command. The program generator 120 can receive a command from the client system 160 via the network 150 to generate a computer program or code. In this example, the pool of models 130 can be generated in the data processing system 102.

The program generator 120 can be located in or on a server. In this example, the client system 160 can include or utilize the data processing system 102. In another example, a server can receive or obtain a command from one or more client systems 160 via the network 150 to generate code or a computer program, where the pool of models 130 is generated on the server. The server can include one or more components of the data processing system 102. The server can include or be the data processing system 102. The server can use the program generator 120 or one or more components of the program generator 120 to generate code or computer programs. The server can generate code or one or more computer programs.

In an example, one or more client systems 160 can generate one or more computer programs or code. The client system 160 can include the program generator 120. The client system 160 can generate code using the pool of models 130. In this example, the pool of models 130 can be distributed on one or more client systems 160 or one or more data processing systems 102.

In another example the program generator 120 can include, provide, execute, operate or otherwise utilize one or more pool orchestration component 122, different from the pool of models, to select, based on the command, a profile of parameters from the parameter dictionary 118 to initialize the pool of models 130. The pool orchestration component 122 can select the parameter dictionary using the network operation or computing environment 104. The program generator 120 can use a machine learning model 114 to identify a plurality of parameters based on the type of network operation indicated by the command. The program generator 120 can select the parameter dictionary 118 corresponding to a type of network operation and a type of the computing environment 104. The pool of model 130 can select the parameter dictionary 118 corresponding to the type of network operation and the type of computing environment 104. The program generator 120 can input the type of network operation or the type of computing environment 104 into a machine learning model 114 to generate a computer program.

The program generator 120 can include, provide, execute, operate or otherwise utilize one or more pool initializers 108 to initialize the pool of models 130. For example, the pool initializer 108 can use the parameter dictionary 118 to initialize the pool of models 130. The pool initializer 108 can use parameter dictionary 118 corresponding to the type of the network operation and the type of the computing environment 104 to initialize the pool of models 130. The pool initializer 108 can initialize the pool of models 130 using the parameters identified by the machine learning model 114. The pool orchestration component 122 can include, provide, execute, operate or otherwise utilize one or more pool initializers to initialize the pool of models 130. The pool initializer 108 can use the profile of parameters selected by the pool orchestrator component 122 to initialize the pool of models 130. The pool initializer 108 can initialize the pool of models 130 by accessing a parameter section of the pool of models 130 replacing each parameter in the parameter section of the pool of models 130 with parameters from the parameter dictionary 118. The pool initializer 108 can initialize the pool of models by sending the command to the pool of models 130. The pool initializer 108 can initialize the pool of models 130 on one or more client systems 160. In this example, the client system 160 can be distributed. In another example, the pool initializer 108 can initialize each model of the pool of models 130 where the each respective model is located on one or more client systems 160.

The pool of models 130 can utilize, include, or operate one or more selectors 132. The selector 132 can include any combination of hardware and software for selecting evaluating and selecting computer programs. The selector 132 can evaluate the computer programs based on performance metrics, evaluation metrics, or the number of votes a computer program receives from each model of the pool of models 130. The performance metrics can include error events, latency, central processing unit (CPU) cycles, memory usage, network bandwidth utilizations, the amount of procedure calls, the amount of program calls, the time complexity of the computer program, or the space complexity of the computer program. The evaluation metric can include the performance metric, time complexity, space complexity, evaluation feedback from a benchmark framework, evaluation feedback from static analyzers, evaluation feedback from linters, or any combination thereof. In some examples, the selector 132 can utilize, include, or operate one or more of the model components 140 to evaluate the computer programs. The selector 132 can evaluate the computer programs using simulated tests. The selector’s 132 evaluation can be different from the performance evaluator’s 110 evaluation of the computer program. The selector 132 can use different performance metrics than the performance evaluator 110. The selector 132 can evaluate the computer program by causing the pool of models 130 to generate a plurality of computer programs and communicate with each model of the pool of models 130 to determine which computer program can satisfy the network operation in accordance with predetermined standards received by the client system 160 or the network operation.

The selector 132 can select, based on an evaluation of the plurality of computer programs, a first computer program from the first plurality of computer programs, the selection is based on the first computer program satisfying a performance metric. For example, the first computer program can satisfy the performance metric by satisfying the time complexity or space complexity set by the program generator 120 or contained in the network operation. In some examples, the pool of models 130 can evaluate a plurality of computer programs. In this example, the pool of models 130 can evaluate the plurality of computer programs by each respective model of the pool of models 130 using its tools component 144. The pool of models’ 130 tools component 144 can evaluate the plurality of computer programs using linters, analyzers (e.g., code analyzers, static analyzers), compilers, filtering mechanisms, or any combination thereof. Each model from the pool of models 130 can assign each computer program from the plurality of computer programs a score or a rating that indicates how well the computer program performs a function or satisfies the performance metric. In this example, each model from the pool of models 130 can base the score using the feedback from the tool components 144 where the feedback can include syntax errors, stylistic errors, unused variables, type errors, logical errors, code bugs, security vulnerabilities, compliance violations, dependency issues, concurrency issues, memory leaks, performance bottlenecks, performance issues, or any combination thereof. The pools of models 130 can then assign a score to each generated computer program where the score indicates the computer program with the lowest amount of feedback. In another instance, the selector 132 can select, based on an evaluation by the pool of models 130 of the plurality of computer programs, a first computer program from the first plurality of computer programs that satisfies a performance metric. In some examples. the selector 132 can evaluate the plurality of computer programs. The selector 132 can evaluate the plurality of computer programs by brainstorming, discussing the error, plan how to solve, and asking each model of the pool of models 130 for a solution. The selector 132 can evaluate the plurality of computer programs using the performance metric. The selector 132 can analyze the plurality of computer programs to measure the performance metrics of the computer programs. The selector 132 can utilize, include, or operate one or more model components 140 of the pool of models 130 to evaluate the plurality of computer programs. The selector 132 can provide the plurality of computer programs to each model of the pool of models 130 to cause each model of the pool of models 130 to evaluate, based on the memory component 142 of each model of the pool of models 130, the plurality of computer programs. The selector 132 can determine, based on an application of a plurality of evaluation tools, the first computer program comprises code that satisfies an evaluation metric. The selector 132 can select, based on the votes received by the pool of models 130, the computer program from the plurality of computer programs that satisfies a voting threshold. For example, the voting threshold can include the highest number of votes, a majority of votes, or more than half the votes. Each model from the pool of models 130 can vote on the plurality of computer programs. For example, the selector 132 can select the highest voted computer program after the pool of models 130 generates one hundred computer programs. In some examples, each model from the pool of models 130 can vote on a computer program made up from one or more computer programs from the plurality of computer programs. The selector 132 can select, based on the evaluation of the plurality of computer programs, a computer program from the plurality of computer programs using the memory component 142. The selector 132 can initialize a voting sequence, the sequence to cause the pool of models 130 to vote on the plurality of computer programs based the evaluation of the computer program by each model of the pool of models 130

The data processing system 102 can utilize, include, or operate one or more performance evaluators 110. The performance evaluator 110 can evaluate the computer program using a sandbox environment and a computing environment 104. In some examples, the performance evaluator can utilize, include, or operate one or more machine learning models 114. The performance evaluator 110 can include logging and monitoring tools to evaluate the performance of computer programs that are executed in the sandbox environment. The performance evaluator 110 can measure the time complexity of a program, the space complexity of a program, or how many remote procedure calls a program makes. The performance evaluator 110 can evaluate the solution of the first program comprising the first computer program, or the solution of the second program comprising the second computer program. The performance evaluator 110 can evaluate a solution of a program. The program can comprise one or more computer programs received from the pool models 130.

The performance evaluator 110 can execute, responsive to the selection, the first computer program in the computing environment. The selection can include the selector 132 selecting, based on an evaluation of the plurality of computer programs, a first computer program from the first plurality of computer programs. In another example, the performance evaluator 110 can execute, responsive to the selection of the selector 132, a first computer program in the sandbox environment corresponding to the computing environment 104. The first computer program can be or include the second computer program or third computer program. The first computer program can be or include the first computer program. For example, the first computer program can include a computer program to complete a tax related document, transfer currency from one bank account to another, complete a payroll request, complete a human resources request, manage servers, analyze network operations, or any combination thereof. The performance evaluator 110 include, provide, execute, operate or otherwise utilize one or more sandbox builder 112 to build or configure a sandbox environment. The sandbox builder can use the computing environment 104 located on the data processing system 102 or the client system 160 to build the sandbox environment. The sandbox builder 112 can include one or more virtualization tools, security features, resource management, interfaces 106, integration capabilities, logging and monitoring, API access, or any combination thereof. The sandbox environment can include one or more virtual machines, emulators, network simulation tools, data sets, security tools, automated testing tools, debugging tools, configuration management tools, application programming interface (API) simulators, containerization tools, dependency management tools, user interface (UI) testing tools, performance testing tools, or any combination thereof. The sandbox environment can include one or more data schemas, system architectures, data, virtual machines, emulators, network simulation tools, data sets, security tools, version control systems, automated testing tools, performance testing tools, containerization tools, application programming interface (API) simulators, user interface (UI) testing tools, configuration management tools, debugging tools, or any combination thereof. In some examples, the data can be configured for the data schema. For example, the sandbox builder 112 can configure the sandbox environment to comprise a data schema, a system architecture, and data configured for the data schema, where the data schema and system architecture are configured to facilitate a transfer of currency. The transfer of currency can include a routing of money from one bank account to another, a payroll transaction, a transfer of a predetermined amount of currency from one bank account to another. In another example, the sandbox builder 112 can configure the sandbox environment to comprise a data schema, a system architecture, and data configured for the data schema, where the data schema and system architecture are configured to complete a tax related document. The performance evaluator 110 can evaluate the execution of one or more computer programs in the sandbox environment. The performance evaluator 110 can be located on one or more client systems 160. The performance evaluator 110 can evaluate one or more computer programs generated on one or more client systems 160.

The performance evaluator 110 can evaluate the performance of the execution of the first computer program in the computing environment 104. The performance evaluator 110 can evaluate the performance of the execution of the first computer program by evaluating the output of the computer program and comparing the output of the computer program with the network operation. The performance of the execution of the first computer program can include completing a tax document, executing a payroll operation, executing a human resources operation, and executing a compliance operation. The performance evaluator 110 can utilize the machine learning model 114 to evaluate the performance of the execution of the first computer program. For example, the computer program can output a completed tax document and the performance evaluator 110 can use a machine learning model (e.g., machine learning model 114) to compare the completed tax document with the tax document, rules and standards contained in the network operation to determine if the output of the computer program was in accordance with the rules, and standards contained in the network operation. In another example, the computer program can be configured to execute a payroll operation, and the performance evaluator 110 can evaluate the performance of the execution of the payroll operation by utilizing the machine learning model to determine that the payroll operation has taken place using the amount and, on the date, as indicated by the network operation. In an example, the client system 160 can include one or more perform evaluator 110. In this example, one or more client systems 160 can utilize the performance evaluator 110 to evaluate one or more computer programs.

The performance evaluator 110 can determine, based on an evaluation of the execution of the first computer program in the sandbox environment, that the first computer program does not satisfy at least one performance metric. For example, the performance metric can include satisfying or completing the network operation. For example, the performance evaluator 110 can determine the computer program from the execution of the first computer program does not satisfy at least one performance metric when the first computer program does not meet the standards set in the network operation. In another example, the performance evaluator 110 can determine the first computer program does not satisfy at least one performance metric when then execution of the computer program cause the computer program to return output that does not satisfy the network operation. For example, the network operation can indicate a request to complete a tax document along with the tax document to be completed and the pool of models 130 can generate a program to complete the documents. In this example, the performance evaluator 110 can determine that the first computer program does not satisfy at least one performance metric by comparing the output of computer program with the network operation to determine if the output does not complete or otherwise perform the network operation in a satisfactory manner. In this example, the output of the first computer program can not complete or satisfy the network operation when the output of the computer program does not complete the document or operation in the network operation according to standards and rules stored or contained in the network operation, data repository 116, or data processing system 102. In some examples, the first computer program can include completed tax related documents, and the network operation can include tax code, tax laws, a tax related document, instructions on how to fill out the tax related document, or any combination thereof. In this example, the performance evaluator 110 can use machine learning model 114 and the network operation to evaluate the first computer program according to the tax code, tax laws, the tax related document and the instructions on how to fill out the tax related document contained in the network operation. The performance metric can include performance metrics determined by the ML model 114. In this example, the ML model 114 can determine the performance metrics based on the type of the network operation, the type of computing environment 104, the command, or the computer program generated by the pool of models 130. The ML model 114 can establish the thresholds for satisfying the performance metrics based on the command, the network operation, or the type of computing environment 104. The ML model 114 can indicate which performance metric has the highest priority to the pool of models 130 before the pool of models 130 generate computer program based on the command, input from the client system 160, the network operation, or the computing environment 104.

In another example, the performance evaluators 110 can use a benchmarking tool to determine that the first computer program does not satisfy at least one performance metric of the performance metric. In some examples, the performance evaluator 110 can analyze the first computer program to determine that the first computer program does not satisfy at least one performance metric of the performance metric. The performance evaluator 110 can determine, based on an evaluation of the execution of the first computer program in the sandbox environment, that the first computer program caused a transfer of a predetermined amount of currency from a first bank account to a second bank account on a predetermined date according to instructions contained in the network operation. For example, the performance evaluator 110 can determine that a predetermined amount of currency was transferred by analyzing difference of the amount of currency in the first bank account and the amount of currency in the second bank account. The performance evaluator 110 can determine, based on an evaluation of the execution of the first computer program in the sandbox environment, that the first computer program completed the tax related document according to standards and instructions contained in the network operation. In this example, the standards and instructions can contain tax code, tax laws, rules outlining how to fill out tax related documents, or any combination thereof. The performance evaluator 110 can determine, based on an application of a plurality of evaluation tools, the first computer program comprises code that satisfies an evaluation metric. The evaluation tool can include linters, static analyzers, and data sets. The data sets can include data sets to be used as benchmark data sets. The performance evaluator 110 can identify, based on the computer program from the machine learning model 114, the performance metric to use to evaluate the plurality of computer programs. For example, the machine learning model 114 can computer program that the program involves a payroll operation. In this example, the performance evaluator 110 can identify additional performance metrics, the additional performance metrics can include whether the indicated amount of currency was debited from a first bank and credited to a second bank account, whether the currency transfer occurred on the indicated date, or whether the transaction complied with tax and labor laws. In another example, the machine learning model 114 can generate a computer program that satisfies the network operation where the network operation includes a tax related document. In this example, the performance evaluator 110 would identify additional performance metrics such as completion of the tax related document according to current tax code rules, adhering to the current tax law, following the instructions provided by the network operation, or maintaining an audit trail.

The data processing system 102 can perform an action, based on the evaluation. In some examples, the action can include sending the command to the pool of models 130, sending the first computer program to the client system 160, storing the first computer program in the data repository 116, or requesting the pool of models 130 generate a plurality of computer programs again. For example, if the evaluation does not satisfy the performance metric, the data processing system 102 can send the pool of models 130 the network operation again to cause the pool of models 130 to generate an additional plurality of computer programs. The pool of models 130 can perform the action, based on the evaluation.

The performance evaluator 110 can generate a second plurality of computer programs using the pool of models 130, each model provided an indication of the performance metric that was not satisfied by the first computer program. In some examples, the performance evaluator 110 can provide an indication of the determination that the first computer program does not satisfy the one performance metric to the pool of models 130 to cause the pool of models 130 to generate a second plurality of computer programs for the program. The performance can provide the indication by sending a message or data packet containing a string of characters indicating the first computer program did not satisfy the performance metric to the pool of models 130. The performance evaluator 110 can provide the indication to the program generator 120, the interface 106, or the pool of models 130. The interface can provide the indication to the client system 160. The indication can include a message indicating the first computer program was incorrect, produced error messages, did not meet a set time complexity, did not meet a set space complexity, did not meet the set requirements, or did not adhere to provided rules. The indication can include or be a data packet, a data object, an array, JavaScript object file (JSON) file, or any combination thereof. In another example, the performance evaluator 110 can prompt the pool of models 130 with an indication, message, network operation, or computing environment (e.g., the computing environment 104) to generate a second plurality of computer programs. In an example, the performance evaluator 110 can stop providing indications to the pool of models 130 after the pool of models 130 generates a threshold number of computer programs. The threshold number of computer programs can include ten computer programs, twenty computer programs, or one hundred computer programs. The performance evaluator 110 can cause the pool of models 130 to generate one thousand computer programs. The performance evaluator 110 can select a memory component 142 of each model of the pool of models 130 that corresponds to the context component 146 of each model of the pool of models 130. The performance evaluator 110 can update the memory component 142 of each model of the pool of models 130 with the context component 146 of each respective model of the pool of models 130 based on the parameters of each model of the pool of models 130.

The selector 132 can select, based on an evaluation by the pool of models 130 of the second plurality of computer programs, a second computer program from the second plurality of computer programs that satisfies the performance metric. In an example, the second computer program can satisfy the performance metric by meeting a predetermined time complexity or space complexity indicated by the performance metric. For example, the selector 132 can select, based on the votes received by the pool of models 130, the computer program from the plurality of computer programs that satisfies a voting threshold. For example, the voting threshold can include the highest number of votes, a majority of votes, or more than half the votes. Each model from the pool of models 130 can vote on the plurality of computer programs. In some examples, each model from the pool of models 130 can vote on a computer program made up from one or more computer programs from the plurality of computer programs. The selector 132 can select, based on the evaluation of the plurality of computer programs, a computer program from the plurality of computer programs using the memory component 142. The selector 132 can select based on the plurality of evaluations by the pool of models 130 of the plurality of computer programs, a third computer program, wherein the third computer program differs from the first computer program and the second computer program. For example, the pool of models 130 can evaluate the computer programs by combining the computer programs together and evaluating the combined computer programs. The pool of models 130 can combine the computer programs in accordance with instructions provided by the network operation or using feedback from each model in the pool of models 130. The selector 132 can cause the performance evaluator 110 execute, responsive to the selection, the second computer program in a sandbox environment corresponding to the computing environment after the pool of models 130 generates the second computer program.

The data processing system 102 can execute, responsive to the selection, a second computer program in the computing environment. In another example, the program generator 120 can build, responsive to the selection, a second computer program using the second output to execute the network operation in the computing environment 104. In another example, the program generator 120 can build, responsive to the selection of the second computer program, a second computer program to execute the network operation in the computing environment 104. In one example, program generator 120 can build the second computer program in accordance with the client system 160. The second computer program can include a computer program that fills out tax related documents, completes a tax related document, transfers currency from one bank account to another, completes a payroll request, completes a human resources request, manages servers, analyzes network operations, complete detailed calculations, executes payroll operations, executes human resource operations, operates a benefits administration service, or any combination thereof. The second computer program can include the first computer program. The program generator 120 can execute, responsive to the selection of the third computer program, the third computer program in the sandbox environment corresponding to the computing environment 104. The data processing system 102 can integrate the program into an existing program located on the client system 160 or located on the data processing system 102. The program generator 120 can modify the first or second computer program to execute the network operation in the computing environment in order to make it compatible for a program marketplace.

ML model 114 can include any combination of machine learning algorithms and techniques for generating parameters for the parameter dictionary 118, for use by the pool of models 130, for use by the pool initializer 108. For example, the ML model 114 can be integrated in the pool of models 130, the program generator 120, the performance evaluator 110, or the computing environment 104. ML model 114 can be used to generate code for the pool of models 130, or the program generator 120. For example, ML model 114 can identify parameters from the parameter dictionary 118 to initialize the pool of models 130. In some examples, the ML model 114 can identify the parameters form the parameter dictionary 118 based on the type of network operation, the type of computing environment 104, or the command. The ML model 114 can also be used by the program generator 120 to identify a plurality of parameters based on a type of network operation indicated by the command.

ML model 114 can include any type and form of artificial intelligence (AI) models implementing any AI techniques. For instance, ML model 114 can include generative AI models trained or designed to generate code and programs from data, including models that are trained to generate new content resembling distributions of data on which they are trained. ML model 114 can include generative AI models constructed using variational autoencoders (VAEs), designed to learn latent representations of data and generate new samples based on the representations. ML model 114 can include generative AI models constructed using generative adversarial networks (GANs) that can use a generator and a discriminator to produce a determination or a computer program. ML model 114 can include generate AI models constructed using transformers, which can be designed to learn features or inferences based on sequence-to-sequence capabilities. ML model 114 can utilize generative AI functionality to train and adapt to user characteristics, preferences or device specifications.

ML model 114 can include generative models, such as generative adversarial networks (GANs), natural language processing (NLP) models, such as GPT (Generative Pre-trained Transformer) models, or transformer-based model architectures configured to generate new instances of data based on patterns learned during training. ML models 114 can be trained to generate a program based on the first computer program. ML models 114 can be trained to generate a program using a network operation and the computing environment 104. ML model 114 can include LLMs that can be trained to generate and evaluate programs such as the first program.

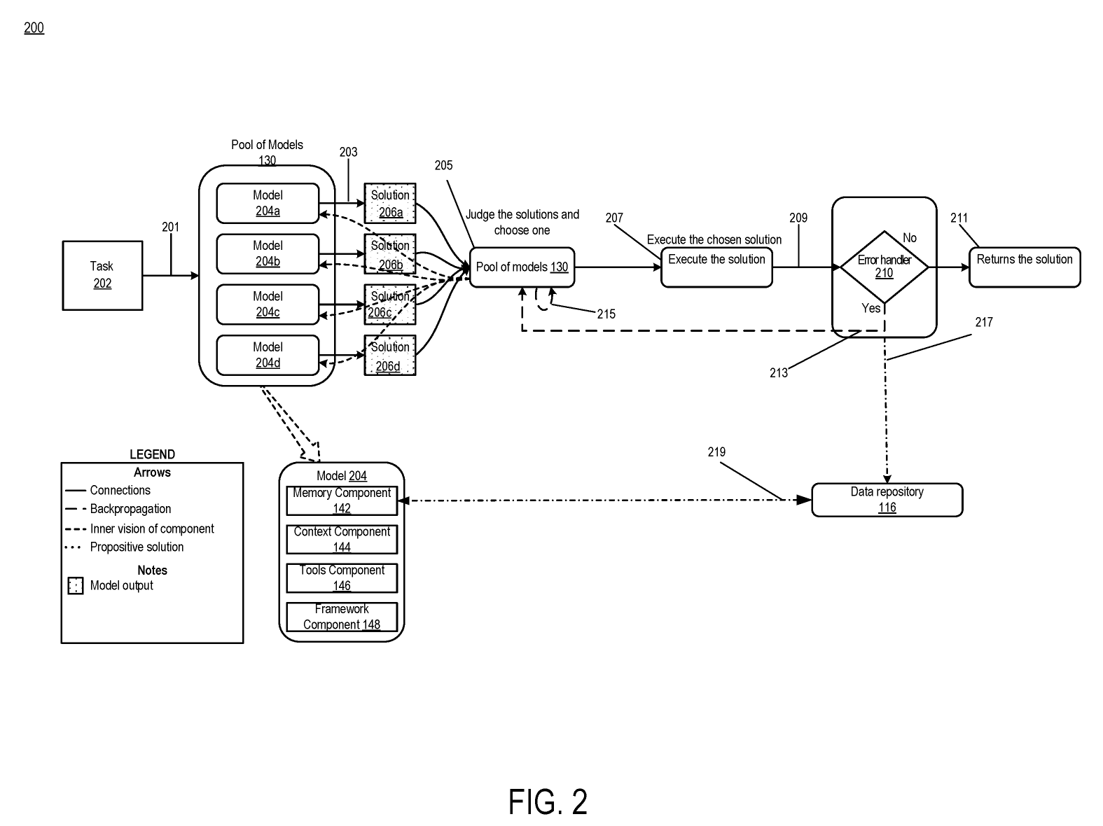

FIG. 2 illustrates an example system 200 of a code generation using a self-learning system, according to one or more aspects. Example system 200 can include one or more tasks 202, pool of models 130 (e.g. of FIG. 1 among others), models 204a-204d, sometimes referred to generally as model(s) 204, solutions 206 (e.g., solutions 206a-206d sometimes referred to generally as solution(s) 206), error handler 210, data repository 116 (e.g., of FIG. 1 among others), memory component 142 (e.g., of FIG. 1 among others), context component 144 (e.g., of FIG. 1 among others), tools component 146 (e.g., of FIG. 1 among others), and framework component 148 (e.g., of FIG. 1 among others).. The pool of models 130 can include a plurality of models 204. The models 204 can include one or more memory component 142, context component 144, tools component 146, or framework component 148. At operation 201, the system 200 can send the task 202 to the pool of models 130 to initialize the pool models. At operation 203, in response to receiving the task 202, each model of the pool of models 130 (e.g., models 204) can generate multiple solutions 206 that are configured to satisfy the task 202. At operation 205, the pool of models 130 (e.g., models 204) can evaluate the solutions 206. The pool of models 130 can evaluate the solutions 206 by receiving all the solutions 206 and voting on one of the solutions 206. The pool of models 130 evaluate the solutions 206 based on which solution satisfies the task 202 efficiently. The solutions 206 can solve the task 202 efficiently by generating a computer program that has the lowest space complexity, lowest time complexity, or lowest remote procedure calls. The solution of the solutions 206 can satisfy the task 202 by not returning an error when run. At operation 207, the system 200 can execute the most voted solution of solutions 206. At operation 209, the pool of models 130 can send the output of the execution of the most voted solution of the solution 206 to the error handler 210. The error handler 210 can evaluate the output of the execution of the most voted solution of solution 206 and detect if the output contains an error. The error handler 210 can detect if the output contains an error by examining the output of the execution of the most voted solution of solutions 206. At operation 211, the error handler can the error handler 210 can return the most voted solution of the solutions 206. For example, the error handler can return the solution if the output of the execution of the most voted solution of solutions 206 does not contain or return an error.

At operation 213, the error handler 210 can return the most voted solution of solution 206 and indicate that the most voted solution contains an error. For example, if the output of the execution of the most voted solution of solutions 206 contains an error, the error handler 210 can propagate the error to the pool of models 130. At operation 215, the pool of models 130 can evaluate the solutions 206 again by brainstorming, discussing any errors the pool of models 130 have received previously, plan how to solve the task 202 received, ask each model 204 of the pool of models 130 to generate another solution 206 , or any combination thereof. At operation 217, the error handler 210 can store information about the execution of the most voted solution of the solutions 206 in the data repository 116. For example, the error handler will store information regarding the success or the error of the execution of the most voted solution of solutions 206. At operation 219, the models 204 can retrieve the relevant information regarding the success or the error of the execution of the most voted solution of the solutions 206 from the data repository 116 and the models 204 can store the relevant information in the memory component 142. For example, the models 204 can determine which information in the data repository 116 is relevant using a machine learning model (e.g., machine learning model 114 among others).

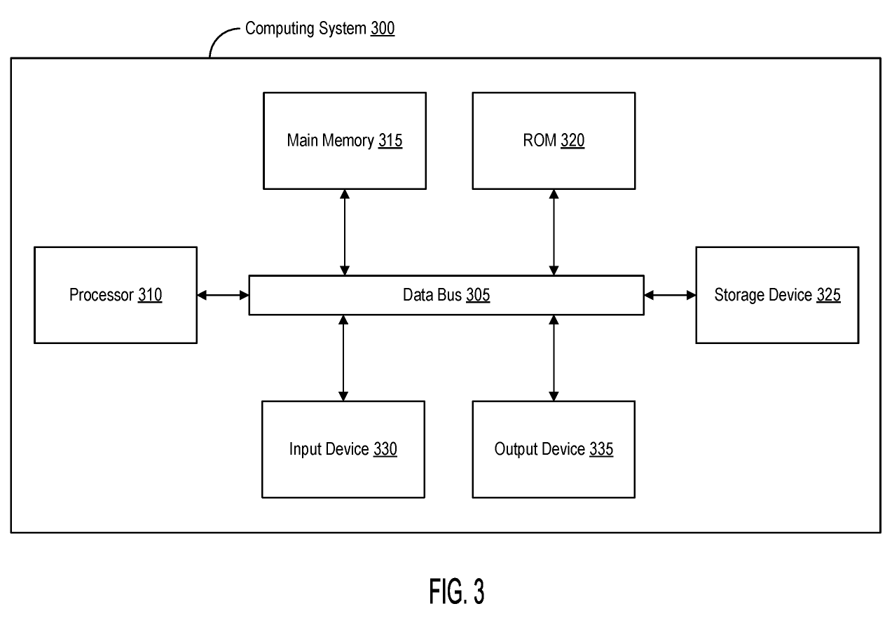

FIG. 3 illustrates a block diagram of a computing system 300 for implementing the embodiments of the present solution, in accordance with embodiments. FIG. 3 illustrates a block diagram of an example computing system 300, which can also be referred to as the computer system 300. Computing system 300 can be used to implement elements of the systems and methods described and illustrated herein, such as for example, commands, instructions or data described herein. Computing system 300 can be included in, provide support for, or run any device (e.g., client system 160 or data processing system 102), or any other feature or component described herein.

Computing system 300 can include at least one bus data bus 305 or other communication device, structure or component for communicating information or data. Computing system 300 can include at least one processor 310 or processing circuit coupled to the data bus 305 for executing instructions or processing data or information. Computing system 300 can include one or more processors 310 or processing circuits coupled to the data bus 305 for exchanging or processing data or information along with other computing systems 300. Computing system 300 can include one or more main memories 315, such as a random-access memory (RAM), dynamic RAM (DRAM), cache memory or other dynamic storage device, which can be coupled to the data bus 305 for storing information, data and instructions to be executed by the processor(s) 310. Main memory 315 can be used for storing information (e.g., data, computer code, commands or instructions) during execution of instructions by the processor(s) 310.

Computing system 300 can include one or more read only memories (ROMs) 320 or other static storage device 325 coupled to the bus 305 for storing static information and instructions for the processor(s) 310. Storage devices 325 can include any storage device, such as a solid state device, magnetic disk or optical disk, which can be coupled to the data bus 305 to persistently store information and instructions.

Computing system 300 can be coupled via the data bus 305 to one or more computer program devices 335, such as speakers or displays (e.g., liquid crystal display or active matrix display) for displaying or providing information to a user. Input devices 330, such as keyboards, touch screens or voice interfaces, can be coupled to the data bus 305 for communicating information and commands to the processor(s) 310. Input device 330 can include, for example, a touch screen display (e.g., computer program device 335). Input device 330 can include a cursor control, such as a mouse, a trackball, or cursor direction keys, for communicating direction information and command selections to the processor(s) 310 for controlling cursor movement on a display.

The processes, systems and methods described herein can be implemented by the computing system 300 in response to the processor 310 executing an arrangement of instructions provided via main memory 315. Such instructions can be read into main memory 315 from another computer-readable medium, such as the storage device 325. Execution of the arrangement of instructions contained in main memory 315 causes the computing system 300 to perform the illustrative processes described herein. One or more processors 310 in a multi-processing arrangement can also be employed to execute the instructions contained in main memory 315. Hard-wired circuitry can be used in place of or in combination with software instructions together with the systems and methods described herein. Systems and methods described herein are not limited to any specific combination of hardware circuitry and software.

Although an example computing system has been described in FIG. 3, the subject matter including the operations described in this specification can be implemented in other types of digital electronic circuitry, or in computer software, firmware, or hardware, including the structures disclosed in this specification and their structural equivalents, or in combinations of one or more of them.

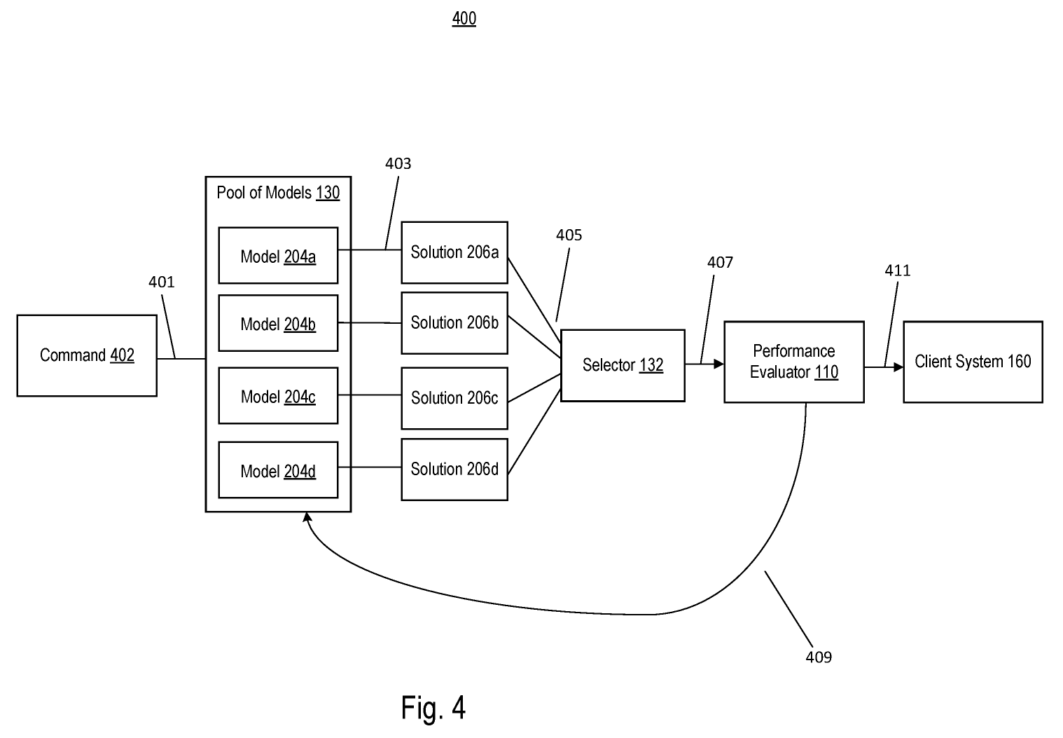

FIG. 4 illustrates an example system 400 of a code generation using a self-learning system, according to one or more aspects. Example system 400 can include one or more commands 402, pool of models 130, models 204, solutions 206, selector 132, performance evaluator 110, or client system 160. The command 402 can include a network operation indicative of a task. The pool of models 130 can include models 204.

At operation 401, the pool of models 130 can receive the command 402. The command 402 can include a networking operation, a tax document, a payroll operation, an HR operation, or a compliance operation. The command can include an indication of request to generate a computer program comprising computer executable instructions that execute a network operation in a computing environment. The command can include network operations, tax documents, payroll operations, instructions related to the network operation, rules, or standards. The rules and standards can be related to the network operation.

At operation 403, the pool of models 130 (e.g., models 204) can generate solutions 206. Solutions 206 can include a plurality of computer programs. For example, the pool of models 130 (e.g., models 204) can be configured or designed to build a computer program in accordance with the command 402. The solutions 206 can contain one or more computer programs.

At operation 405, the pool of models 130 can send the solutions 206 to the selector 132. For example, the selector 132 can cause the pool of models 130 (e.g., models 204) to vote on solutions 206 where the models 204 vote based on which solution 206 adheres to the command 402, and follows the instructions, rules and standards contained in the command 402. The models 204 can vote on solutions 206 based on which solution of the solutions 206 returns the least number of errors after being analyzed by the models 204 using tools such as a compiler, a code linter and a static analyzer.

At operation 407, the selector 132 can provide the highest voted solution of the solutions 206 to the performance evaluator 110. The performance evaluator 110 can execute the highest voted solution and evaluate the performance of the execution of the highest voted solution.

At operation 409, the performance evaluator 110 can send an indication of the performance of the highest voted solution to the pool of models 130 to cause the pool of models 130 to generate another plurality of solutions 206. For example, the performance evaluator 110 can send the highest voted solution to the pool of models 130 to cause the pool of models 130 to generate another plurality of solutions when the highest voted solution’s performance does not satisfy the command 402.

At operation 411, the performance evaluator 110 can send the highest voted solution to the client system 160. For example, the performance evaluator 110 can send the highest voted solution to the client system 160 when the highest voted solution satisfies the command 402.

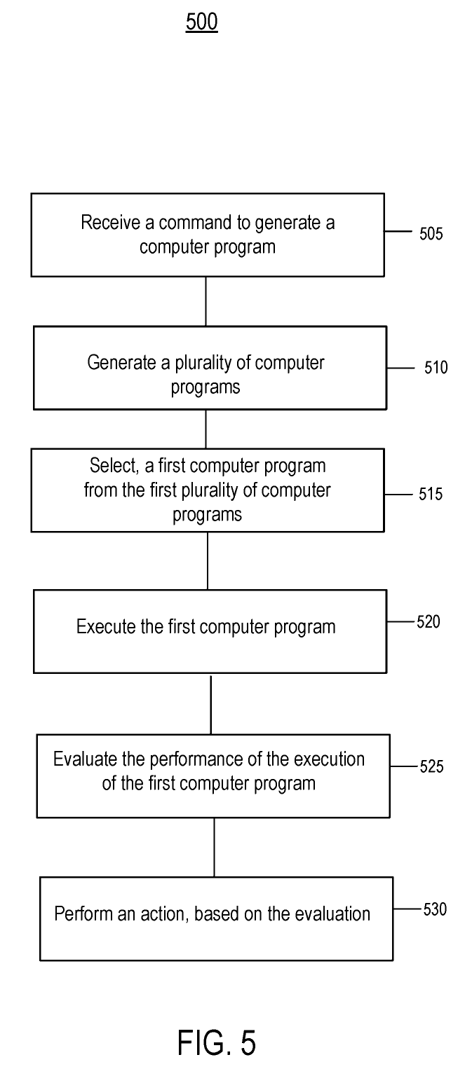

FIG. 5 illustrates a flow diagram of a method 500 for code generation using a self-learning system. The method 500 can be performed by one or more systems or components depicted in FIGS. 1–4, including, for example, a data processing system 102 of FIG. 1, based on instructions, computer code or data stored on memory (e.g., 315, 320 or 325) of a computing system 300. At a high level, method 500 can include acts 505-530. At 505, the method can receive one or more commands to generate a computer program. At 510, the method can generate a plurality of computer programs. At 515, the method can select, a first computer program from the first plurality of computer programs. At 520, the method can execute the first computer program. At 525, the method can evaluate the performance of the first computer program. At 530, the method can perform an action, based on the evaluation.

At 505, the method can receive one or more commands to generate a computer program comprising computer-executable instructions that execute a network operation in a computing environment. The method can include one or more processors coupled with memory executing a data processing system 102. The data processing system 102 can receive, via one or more interfaces, the one or more commands. For instance, the data processing system 102 can receive a command to build a program configured to execute a network operation in a computing environment 104. For example, the one or more processors can receive, using the one or more interfaces, one or more commands configured to execute a network operation. The network operation can include one or more tax documents, payroll operations, HR actions, or compliance actions.

At 510, the method can generate a plurality of computer programs using a pool of models 130, each model initialized using a respective parameter dictionary 118. The method can include the data processing system 102 providing the command to a pool of models 130 initialized using a parameter dictionary 118 to cause the pool of models 130 to generate a plurality of computer programs for building the program responsive to the command. The command can be a command containing a network operation and a computing environment. The program can be a program that is designed to complete one or more of the network operations provided. The program can be a program that can complete tax related documents, implement HR actions on HR systems, implement payroll operations, or implement compliance actions on computing systems. The program can be configured to run on the client system’s computing environment using the client system’s data or data from the data repository of the data processing system. The program can be configured to run on different system architectures, different sandbox environments, or as a containerized application. The program can be configured to be modified by the pool of models 130, the evaluator or the client system 160.

The method can include the program generator 120 selecting one or more parameter dictionaries corresponding to the type of network operation and the type of computing environment and use the pool initializer 108 to use the parameter dictionary 118 corresponding to the type of network operation and the type of computing environment to initialize the pool of models 130. For example, the parameter dictionary 118 can contain parameters to initialize the pool of models. The parameters can include at least one of a temperature parameter, a memory parameter, a randomness parameter, a context parameter, a model parameter, a role parameter or an engine parameter. The program generator 120 can retrieve the parameter dictionary 118 from the data repository. The pool initializer 108 can use a machine learning model 114 to identify a plurality of parameters based on the type of network operation indicated by the command. The pool initializer 108 can initialize the pool of models using the parameter identified by the machine learning model 114.

At 515, the method can select, based on an evaluation by the pool of models 130 of the plurality of computer programs, a first computer program from the first plurality of computer programs, the selection is based on the first computer program satisfying a performance metric. The method can include the data processing system 102 selecting, based on an evaluation by the pool of models 130 of the plurality of computer programs, a first computer program from the first plurality of computer programs that satisfies a performance metric. The data processing system 102 can select the first computer program by selecting the computer program with the most votes by the pool of models 130 and that satisfies the performance metric. The data processing system 102 can select the first computer program by evaluating all of the computer programs from the plurality of computer programs using the performance evaluator 110. The first computer program can satisfy the performance metric by adhering to a predetermined time complexity, a predetermined space complexity, a predetermined amount of procedure calls, or a predetermined execution time. The evaluation can replicate the social dynamics of programmers. The evaluation can include collaborating, reviewing and learning from errors.

The method can include the data processing system 102 selecting the parameter dictionary 118 corresponding to the type of network operation and the type of computing environment to initialize the pool of models 130 and use the parameter dictionary 118 corresponding to the type of network operation and the type of computing environment 104 to initialize the pool of models 130. The pool initializer 108 can select the parameter dictionary 118 corresponding to the type of network operation and the type of computing environment 104 to initialize the pool of models 130 and use the parameter dictionary 118 corresponding to the type of network operation and the type of computing environment to initialize the pool of models. The program generator can identify the corresponding parameter dictionary based on the type of network operation received. The data processing system 102 can determine what parameters to include or use based on the type of network operation. For example, based on the type of network operation, the data processing system 102 can determine the parameter dictionary 118 is to include various values or settings for the following parameters: temperature, memory, randomness, context, type of model, or type of engine to assign to each model.

In an illustrative example, if the type of network operation is to prepare tax documents, then the values for parameters in the parameter dictionary 118 can be as follow: the temperature parameter can be set to “low”, the memory parameter can be set to “0” or “off”, the randomness parameter can be set to high, the context can be set to “on” or “1”, the model can be set to “AI generative”, and the type of engine can be “tensor flow.”

The method can include the data processing system 102 using a machine learning model to identify a plurality of parameters based on a type of network operation indicated by the command. For example, the machine learning model 114 can identify the plurality of parameters based on previous parings of parameters with network operations, or the text of the network operation, The type of network operation can include a request to generate a program to: complete a tax related document, complete a payroll action, to complete an HR action, or check if a system is compliant with a set of predefined rules provided by the network operation.

The method can include the data processing system 102 selecting, based on a plurality of evaluations by the pool of models 130 of the plurality of computer programs, a third computer program, wherein the third computer program differs from the first computer program and the second computer program. For example, the selector 132 can select, based on a plurality of evaluations by the pool of models of the plurality of computer programs, a third computer program, wherein the third computer program differs from the first computer program and the second computer program. The plurality of evaluations can include each model of the pool of models 130 generating different computer programs and voting on which combination of computer programs best solves the request in the network operation. The selector 132 can select, determine or validate that the third computer program satisfies the performance metrics. The selector 132 can send the third computer program to the performance evaluator 110. The selector 132 can select the third computer program based on the computer program satisfying the performance metrics and the requirements of the computing environment.

The method can include the pool initializer 108 initializing the pool of models using the parameters identified by the machine learning model. For example, the pool initializer 108 can initialize the pool of models 130 by assigning the parameters to each model of the pool of models 130. The pool initializer can initialize each model of the pool of models 130 with different parameters for each model. The pool initializer can initialize each model of the pool of models 130 with different memory parameters that allows some of the models of the pool of models to have memory and some models of the pool of models to not have memory.

The method can include the program generator 120 using a pool orchestrator component, different from the pool of models 130, to select, based on the command, a profile of parameters from the parameter dictionary 118 with which to initialize the pool of models 130. For example, the program generator 120 can use the pool orchestrator component 122 to select a profile of parameters from the parameter dictionary 118 based on the

At 520, the method can execute, responsive to the selection, the first computer program in the computing environment. The method can include the data processing system 102 executing, responsive to the selection, a first computer program in a sandbox environment corresponding to the computing environment 104. For instance, the first computer program can be a computer program configured to solve complex and ambiguous issues in tax related documents. The first computer program can be configured to capture nuances and explore multiple interpretations of a document’s rules and regulations. The first computer program can be a computer program configured to execute payroll operations. The first computer program can be a computer program configured to execute an HR operation.

The method can include the performance evaluator 110 configuring the sandbox environment to comprise a data schema, a system architecture and data configured for the data schema, where the data schema and system architecture are configured to complete a tax related document.

The method can include the performance evaluator 110 configuring the sandbox environment to comprise a data schema, a system architecture and data configured for the data schema, where the data schema and system architecture are configured to facilitate a transfer of currency.

The method can include the performance evaluator 110 configuring the sandbox environment, based on a type of the network operation or a type of the computing environment, to include a containerized application, a data schema, a virtual machine, a system architecture, or data configured for the data schema.

At 525, the method can evaluate the performance of the execution of the first computer program in the computing environment. The method can include the data processing system 102 determining, based on an evaluation of the execution of the first computer program in the sandbox environment, that the first computer program does not satisfy the at least one performance metric of the performance metric. For example, the performance evaluator 110 can determine that the first computer program does not satisfy the at least one performance metric of the performance metric by measuring the time complexity of the first computer program. For example, the performance evaluator 110 can determine the first computer program does not satisfy the performance metric when the first computer program contains functionally correct code.

The method can include the performance evaluator 110, determining, based on an application of evaluation tools, the first computer program comprises code that satisfies an evaluation metric. For example, the evaluation metric can include the functional correctness of the code, whether the code is able to be compiled successfully, or whether the code is optimized enough to meet predetermined time complexity and space complexity thresholds.

The method can include the performance evaluator 110 determining, based on an evaluation of the execution of the first computer program in the sandbox environment, that the first computer program completed the tax related document according to standards and instructions contained in the network operation. For example, the first computer program can include a program configured to capture nuanced interpretations of tax related documents.

The method can include the performance evaluator 110 identifying, based on the computer program from the machine learning model, the performance metric to use to evaluate the plurality of computer programs. For example, the machine learning model 114 can identify performance metrics based on the type of network operation, or the computing environment 104.

The method can include the performance evaluator 110 initializing a voting sequence, the sequence to cause the pool of models 130 to vote on the plurality of computer programs based on the evaluation of the computer program by each model of the pool of models 130. For example, the performance evaluator 110 can cause the pool of models 130 to vote on the plurality of computer programs in order to determine which computer program of the plurality of computer programs is most optimized and offers the closest solution to the request contained in the network operation. The pool of models 130 can vote among themselves to choose computer programs that when combined, solve the request contained in the network operation. The pool of models can vote on individual computer programs to combine, and combinations of computer programs based on solving the request from the network operation.

The method can include the performance evaluator 110 providing the plurality of computer programs to each model of the pool of models 130 to cause the models to evaluate, based on the memory component of each model of the pool of models 130, the plurality of computer programs. The memory component of each model of the pool of models 130 can differ from other models of the pool of models 130 based on the memory parameter setting, the role of the model, or parameters used to initialize the model.

The method can include the program generator 120 selecting a memory component of each model of the pool of models 130 that correspond to the context component of each model of the pool of models 130 and updating the memory component of each model of the pool of models with the context component of each respective model of the pool of models 130 based on the parameters of each model of the pool of models 130. For example, after each evaluation, each model of the pool of models can update its memory component using its context component and then clear its context component.

At 530, the method can perform an action, based on the evaluation. For example, the data processing system 102 can perform an action based on the data processing system 102 evaluating the performance of the execution of the first computer program in the computing environment. The action can include sending an indication that the performance of the execution of the first computer program did not satisfy the performance metric or sending an indication that the performance of the execution of the first computer program satisfied the performance metric. The action can cause the pool of models 130 to generate plurality of computer programs that differ from the first plurality of computer programs. The action can cause each model of the pool of models 130 to debate amongst each other model of the pool of models 130, generate a plurality of computer programs, and vote on which program satisfies the network operation based on each model of the pool of models 130 analyzing each program.

The method can include providing an indication to the pool of models 130 to cause the pool of models 130 to generate a second plurality of computer programs. The method can include the program generator 120 providing an indication of the determination that the first computer program does not satisfy the one performance metric to the pool of models 130 to cause the pool of models 130 to generate a second plurality of computer programs for the program. The second plurality of computer programs can be generated using the type of the network operation and the type of the computing environment. The second plurality of computer programs can be generated using the network operation and the computing environment 104.

The method can include selecting a second computer program from the second plurality of computer programs that satisfies the performance metric. The method can include the performance evaluator selecting, based on an evaluation by the pool of models of the second plurality of computer programs, a second computer program from the second plurality of computer programs that satisfies the performance metric. For example, the second computer program can include a program configured to solve or complete the network operation. For instance, the network operation can include tax related documents, and rules and regulations regarding the tax related document, and the second computer program can be configured to complete or solve the tax related document while adhering to the rules and regulations of the tax related document.

The method can include the selector selecting, based on a plurality of evaluations by the pool of models 130 of the plurality of the computer programs, a third computer program, wherein the third computer program differs from the first computer program and the second computer program. For example, the third computer program can be based on multiple rounds of evaluations by the pool of models 130 regarding multiple computer programs in order capture diverse interpretations of the tax related document in the network operation.

The method can include the selector 132 selecting, based on the votes received by the pool of models, the computer program from the plurality of computer programs that satisfies a voting threshold. For example, the computer program can be single part of a program or a whole program configured to complete or solve a tax related document.

The method can include building the program to execute the network operation in the computing environment. The method can include the data processing system 102 building, responsive to the selection, a second program using the second computer program to execute the network operation in the computing environment. The second program can include the same functions as the first program. The data processing system 102 can use the program generator 120 to build the second program.

The method can include executing, responsive to the selection, the third computer program in the sandbox environment corresponding to the computing environment 104.

Having now described some illustrative implementations, the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations.

The phraseology and terminology used herein is for the purpose of description and should not be regarded as limiting. The use of "including," "comprising," "having," "containing," "involving," "characterized by," "characterized in that," and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

References to "or" may be construed as inclusive so that any terms described using "or" may indicate any of a single, more than one, and all of the described terms. References to at least one of a conjunctive list of terms may be construed as an inclusive OR to indicate any of a single, more than one, and all of the described terms. For example, a reference to "at least one of 'A' and 'B'" can include only 'A', only 'B', as well as both "A' and 'B'. Such references used in conjunction with "comprising" or other open terminology can include additional items. References to "is" or "are" may be construed as nonlimiting to the implementation or action referenced in connection with that term. The terms "is" or "are" or any tense or derivative thereof, are interchangeable and synonymous with "can be" as used herein, unless stated otherwise herein.

Directional indicators depicted herein are example directions to facilitate understanding of the examples discussed herein, and are not limited to the directional indicators depicted herein. Any directional indicator depicted herein can be modified to the reverse direction or can be modified to include both the depicted direction and a direction reverse to the depicted direction, unless stated otherwise herein. While operations are depicted in the drawings in a particular order, such operations are not required to be performed in the particular order shown or in sequential order, and all illustrated operations are not required to be performed. Actions described herein can be performed in a different order. Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any clam elements.

Scope of the systems and methods described herein is thus indicated by the appended claims, rather than the foregoing description. The scope of the claims includes equivalents to the meaning and scope of the appended claims.

What is claimed is:

1. A system, comprising:
a data processing system comprising one or more processors, coupled with memory, to:
receive a command to generate a computer program comprising computer-executable instructions that execute a network operation in a computing environment;
generate a plurality of computer programs using a pool of models, each model initialized using a respective parameter dictionary;
select, based on an evaluation by the pool of models of the plurality of computer programs, a first computer program from the first plurality of computer programs, the selection is based on the first computer program satisfying a performance metric;
execute, responsive to the selection, the first computer program in the computing environment;
evaluate the performance of the execution of the first computer program in the computing environment; and
perform an action, based on the evaluation.

2. The system of claim 1, the one or more processors to:
determine, based on an evaluation of the execution of the first computer program in a sandbox environment, that the first computer program does not satisfy at least one performance metric;
generate a second plurality of computer programs using the pool of models, each model provided an indication of the performance metric that was not satisfied by the first computer program;
select, based on an evaluation by the pool of models of the second plurality of computer programs, a second computer program from the second plurality of computer programs that satisfies the performance metric; and
execute, responsive to the selection, a second computer program in the computing environment.

3. The system of claim 2, the one or more processors to:
select, based on a plurality of evaluations by the pool of models of the plurality of computer program, a third computer program, wherein the third computer program differs from the first computer program and the second computer program; and
execute, responsive to the selection, the third computer program in the sandbox environment corresponding to the computing environment.

4. The system of claim 1, wherein the parameter dictionary includes at least one of a temperature parameter, a memory parameter, a randomness parameter, a context parameter, a model parameter, or an engine parameter.

5. The system of claim 1, the one or more processors to:
configure a sandbox environment to comprise a data schema, a system architecture and data configured for the data schema, where the data schema and system architecture are configured to facilitate a transfer of currency;
determine based on an application of a plurality of evaluation tools, the first computer program satisfies an evaluation metric; and
determine based on the evaluation of the execution of the first computer program in the sandbox environment, that the first computer program caused a transfer of a predetermined amount of currency from a first bank account to a second bank account on a predetermined date according to instructions contained in the network operation.

6. The system of claim 1, the one or more processors to:
configure a sandbox environment to comprise a data schema, a system architecture and data configured for the data schema, where the data schema and system architecture are configured to complete a tax related document;
determine, based on an application of a plurality of evaluation tools, the first computer program comprises code that satisfies an evaluation metric; and
determine, based on an evaluation of the execution of the first computer program in the sandbox environment, that the first computer program completed the tax related document according to standards and instruction contained in the network operation.

7. The system of claim 1, wherein the execution of the computer program occurs in a sandbox environment corresponding to the computing environment.

8. The system of claim 1, the one or more processors to:
select the parameter dictionary corresponding to a type of network operation and a type of computing environment; and
use the parameter dictionary corresponding to the type of network operation and the type of computing environment to initialize the pool of models.

9. The system of claim 1, the one or more processors to:
use a machine learning model to identify a plurality of parameters based on a type of network operation indicated by the command; and
initialize the pool of models using the parameters identified by the machine learning model.

10. The system of claim 1, the one or more processors to:
input a type of the network operation or a type of the computing environment into a machine learning model to generate a computer program; and
identify, based on the computer program from the machine learning model, the performance metric to use to evaluate the plurality of computer program.

11. The system of claim 1, the one or more processors to:
use a pool orchestrator component, different from the pool of models, to select, based on the command, a profile of parameters from the parameter dictionary with which to initialize the pool of models; and
initialize the pool of models using the selected profile of parameters.

12. The system of claim 1, wherein each model of the pool of models comprises: i) a memory component, ii) a context component, iii) a tools component, and iv) a framework component, the one or more processors to:
store, in the memory component of each model of the pool of models, in accordance with the parameter dictionary used to initialize the pool of models, information related to one or more evaluations of the plurality of computer programs.

13. The system of claim 12, the one or more processors to:
select a memory component of each model of the pool of models that corresponds to the context component of each model of the pool of models; and
update the memory component of each model of the pool of models with the context component of each respective model of the pool of models based on the parameters of each model of the pool of models.

14. The system of claim 12, the one or more processors to:
provide the plurality of computer programs to each model of the pool of models to cause each model of the pool of models to evaluate, based on the memory component of each model of the pool of models, the plurality of computer programs; and
select, based on the evaluation of the plurality of computer programs, an output from the plurality of outputs.

15. The system of claim 1, the one or more processors to:
configure a sandbox environment, based on a type of the network operation or a type of the computing environment, to include a containerized application, a data schema, a virtual machine, a system architecture, or data configured for the data schema.

16. The system of claim 1, the one or more processors to:
initialize a voting sequence, the sequence to cause the pool of models to vote on the plurality of computer programs based the evaluation of the computer program by each model of the pool of models;
select, based on the votes received by the pool of models, the computer program from the plurality of computer program that satisfies a voting threshold; and
execute, responsive to the selection, the computer program that satisfies the voting threshold in a sandbox environment corresponding to the computing environment.

17. A method, comprising:
a data processing system comprising one or more processors, coupled with memory;
receiving, by one or more processors, a command to generate a computer program comprising computer-executable instruction that execute a network operation in a computing environment;
generating, by one or more processors, a plurality of computer programs using a pool of models, each model initialized using a respective parameter dictionary;
selecting, by one or more processors, based on an evaluation by the pool of models of the plurality of computer programs, a first computer program from the first plurality of computer programs, the selection is based on the first computer program satisfying a performance metric;
executing, by one or more processors, responsive to the selection, the first computer program in the computing environment;
evaluating, by the one or more processors, the performance of the execution of the first computer program in the computing environment; and
performing, by the one or more processors, an action, based on the evaluation.

18. The method of claim 17, comprising:
determine, based on an evaluation of the execution of the first computer program in a sandbox environment, that the first computer program does not satisfy at least one performance metric;
generate a second plurality of computer programs using the pool of models, each model provided an indication of the performance metric that was not satisfied by the first computer program;
select, based on an evaluation by the pool of models of the second plurality of computer programs, a second computer program from the second plurality of computer programs that satisfies the performance metric; and
build, responsive to the selection, a second computer program to execute the network operation in the computing environment.

19. The method of claim 17, comprising:
using, by one or more processors, a machine learning model to identify a plurality of parameters based on a type of network operation indicated by the command; and
initializing, by one or more processors the pool of models using the parameters identified by the machine learning model.

20. A non-transitory computer-readable medium comprising instructions that, when executed by one or more processors coupled with memory, cause the one or more processors to:
receive a command to generate a computer program comprising computer-executable instructions that execute a network operation in a computing environment;
generate a plurality of computer programs using a pool of models, each model initialized using a respective parameter dictionary;
select, based on an evaluation by the pool of models of the plurality of computer programs, a first computer program from the first plurality of computer programs, the selection is based on the first computer program satisfying a performance metric;
execute, responsive to the selection, the first computer program in the computing environment;
evaluate the performance of the execution of the first computer program in the computing environment; and
perform an action, based on the evaluation.
